(19) United States
(12) Patent Application Publication
(10) Pub. No.: US 2014/0105450 A1
(43) Pub. Date: Apr. 17, 2014

(54) SYSTEM AND METHOD FOR TARGETING AND READING CODED CONTENT

(71) Applicants: Robert Berkeley, Bedfordshire (GB); Emrys Williams, Bedfordshire (GB); Andrew Perry-Smith, London (GB)

(72) Inventors: Robert Berkeley, Bedfordshire (GB); Emrys Williams, Bedfordshire (GB); Andrew Perry-Smith, London (GB)

(21) Appl. No.: 14/056,751

(22) Filed: Oct. 17, 2013

Related U.S. Application Data
(60) Provisional application No. 61/714,887, filed on Oct. 17, 2012.

(51) Int. Cl. G06K 9/00; G06T 1/00

(52) U.S. Cl. CPC G06K 9/00671; G06T 1/0021
USPC 382/100

(57) ABSTRACT

A method and device using a camera element to recognize and decode “invisible” watermarks. Of particular significance to the present invention is the development of a “designator” that is used to identify the existence of, and if desired, the approximate location of, the watermark or other coded content contained in an actual image such as media content (a displayed website, an printed or electronic advertisement, a label, billboard, brochure or any other means of displaying content) and assist in quick acquisition of the invisible watermark or other coded content by the reading device. A perceived image of the actual image can be optimized using the known characteristics of the designator.

### CROSS-REFERENCE TO RELATED APPLICATIONS

This application is based on, and claims priority to, U.S. Provisional Application No. 61/714,887, filed Oct. 17, 2012, the entire contents of which is fully incorporated herein by reference.

### BACKGROUND OF THE INVENTION

### Field of the Invention

It is known to use “invisible” watermark technology to create a virtual link between content on a printed or digital page (referred to herein as “media content” or an “image” or “actual image”) and a website or microsite or other source of content. These watermarks are more accurately described as “barely visible” since, using current technology, they must be visible enough to be perceived by a reading device of some kind. Ideally they lack the intensity to be visible to the human eye without rigorous inspection. Another term that may be used is a steganographic watermark, which essentially means it is a concealed watermark However, for ease of reference they are referred to herein as invisible watermarks.

While invisible watermarks present interesting marketing opportunities, making the reader/viewer aware that an image contains an invisible watermark can present a challenge. Obviously the reader/viewer cannot readily see the invisible watermark because it is deliberately hidden. Text can be added nearby the image to advise a reader/viewer to use a reading device to read the invisible watermark; however, adding this text could be considered to be unwanted “noise” for the readers/viewers. Further, the image may be much larger than the invisible watermark, which means the reader/viewer will need to aim the reading device at numerous locations of the image and hold it still to “acquire” the invisible watermark before the reading device can read it.

### SUMMARY OF THE INVENTION

The present invention can be embodied in a reading device, for example, a smartphone having a camera element and configured with an app that uses the camera element to recognize and decode an invisible watermark, which then launches a web browser displaying a relevant website or microsite with which a user can interact and get more media rich content (e.g. video/audio), place an order, etc. Of particular significance to the present invention is the development of a “designator” that is used to identify the existence of, and if desired, the approximate location of, an invisible watermark or other coded content contained in media content (a displayed website, an printed or electronic advertisement, a label, billboard, brochure or any other means of displaying content) and assist in quick acquisition of the invisible watermark or other coded content by the reading device. The description of the use of a smartphone is given for the purpose of example only, and it is understood that any device capable of reading, acquiring, and processing invisible watermarks or other coded content can be used to perform the reading/acquiring/processing function described herein including, without limitation, a tablet computing device, a computer equipped with an external or integrated camera, a scanner, and the like.

The designator can be printed or otherwise included on a page to indicate to users that an invisible watermark exists that contains a link to additional web content. This designator can take any shape, size, or configuration and is likely to be reproduced in a number of different colors as it will, on occasion, need to blend in with the color pallet that is used on the page in which it is present. Ideally the designator will always be the same basic configuration so that, regardless of its coloration, users can readily identify it as the designator of the existence of an invisible watermark.

Alternatively, it is also possible to use Mobile Visual Search (MVS) technology as the coded content instead of or in addition to the invisible watermark technology or any other means of presenting coded content. MVS technology is where a query image/photo is taken by a mobile device and compared against a database on a remote server—once the image/photo is recognized, the database responds by sending back digital content, URL's, etc., as appropriate. Effectively, the image is acting as the watermark code. Although there is no separate ‘code’ that needs to be targeted, the designator can be used in the same way in some cases to get the user to target their device at the optimum area and potentially resolve distortions in the image/photo being scanned.

### BRIEF DESCRIPTION OF THE DRAWINGS

FIG. 1 illustrates an example of a designator used in the present invention;

FIG. 2 illustrates the location of the designator on the screen relative to the location of the watermark on the page;

FIG. 3 shows a comparison of the angle between the lens of the viewing device and the watermark in prior art systems and the present invention;

FIG. 4 shows the designator being viewed from two different angles;

FIG. 5 is a flowchart illustrating process steps of the present invention;

FIG. 6 illustrates the search for the designator;

FIG. 7 shows the rotation of an image of FIG. 6;

FIG. 8 shows the image of FIG. 6 scaled uniformly; and

FIG. 9 shows a perspective transformation of the whole image.

### DETAILED DESCRIPTION OF THE PREFERRED EMBODIMENTS

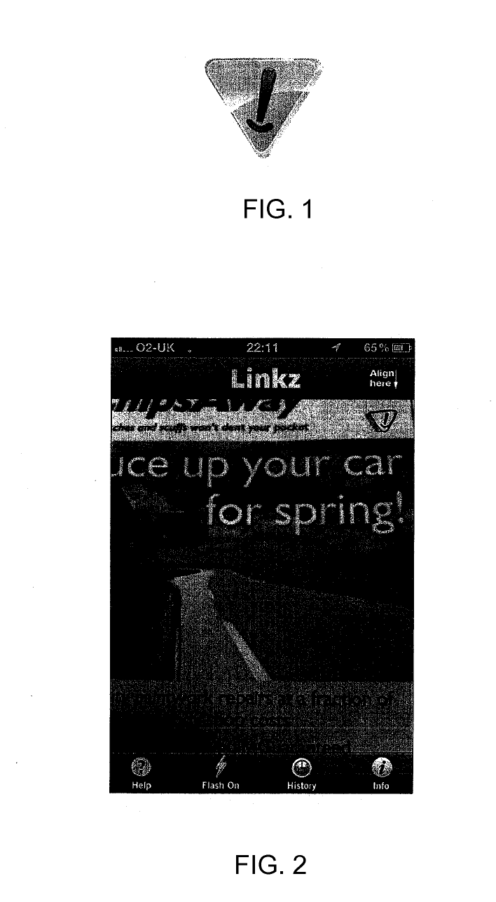

One aspect of the invention is directed to a method and device for targeting the correct area of the actual image with a reading device. On some occasions, an entire page may be overprinted with a watermark, with the result that the method and device of the present invention can scan any part of the page and recognize the invisible watermark and the code contained therein (for example, the invention can electronically scan the an actual image using a camera element, a viewing screen, and processor of a smartphone). However, in many instances (particularly when there is more than one watermark on a page) the watermark will only cover a specific area of the page or actual image, and a user would have to scan the entire page/actual image hunting for the invisible watermark location. An example of a designator that can be used is shown in FIG. 1. The designator can be always positioned at the same location relative to the watermark (e.g., at the top, right hand corner of the watermark) so that users will know exactly where they need to “point” their phone or other reading device.

The method and device of the present invention configure the smartphone or other reading device to display a replica image of the designator at the same location on the screen relative to the location of the watermark on the page (for example, the top, right hand corner of the smartphone screen—see FIG. 2) in the camera mode so that the user can:

a. Line up the image on the page and the replica image on the viewing screen and

b. Hold the phone at the optimum distance from the page (by ensuring that the size of the designator on the page and the replica version on the screen are approximately the same size) to maximize the phone's ability to scan the invisible watermark. Although not visible in FIG. 2, the designator on the screen of the reading device is hovered over the designator on the image and then the reading device is moved until the two are about the same size.

In this context, therefore, the present invention includes:
The use of designator in a specific position relative to a code or watermark to demonstrate the best place on the ‘page’ and distance away to position the phone/device lens to achieve the best possible ‘scan’.
Using a replica of the designator in the app ‘viewfinder’ to help the user correctly position the scanning device in the right place.
In a preferred embodiment, the app of the present invention configures the smartphone or other viewing device to signal to the user when alignment is proper (including, in the most preferred embodiment, proper alignment in the x and y plane as well as proper distance (i.e. in the z plane). This signal can be a visual signal (a flashing indicator), and audible signal, a combination visual and audible signal, words flashed on the screen indicating success and the like.

### 2. Adjusting for Angle/Distortions

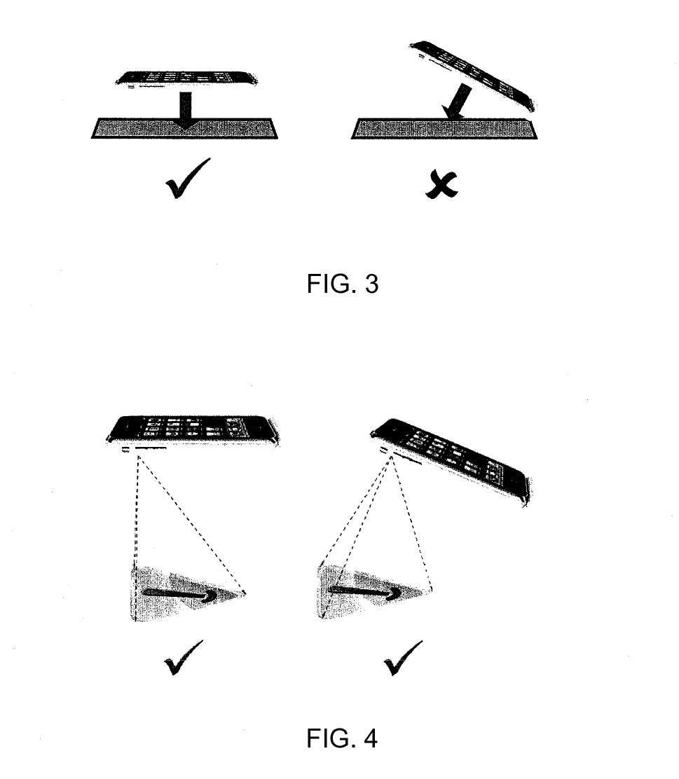

Ideally a user holds the viewing device parallel with the page he or she is scanning. If there is a significant angle between the lens of the viewing device and the watermark or other code, prior are systems for reading the watermark/code have greater difficulty recognizing the code contained in the watermark. See FIG. 3

This makes it difficult to scan a page that cannot be “approached” from the ideal position—for example, an outdoor poster that is above head height. If the device being used to scan the watermark is at too much of an angle, the code will appear distorted to the lens and the apps of the prior art may fail to recognize it. However, using the known information about the designator of the present invention, the angle at which the ‘page’ is being scanned can be determined and then the perceived view of the watermark can be adjusted mathematically so that the watermark can be “virtually perceived” without distortion.

The designator of the present invention can be used for this purpose as the app of the present invention is configured to “know” the dimensions of the designator. FIG. 4 shows the designator of this example being viewed from two different angles, showing how the designator perceived by the reading device might be different depending on the angle at which it is viewed. The app is further configured to calculate the angle of the designator to the device lens and consequently adjust for the same angle while scanning the watermark, filtering out distortion and achieving a ‘good’ scan.

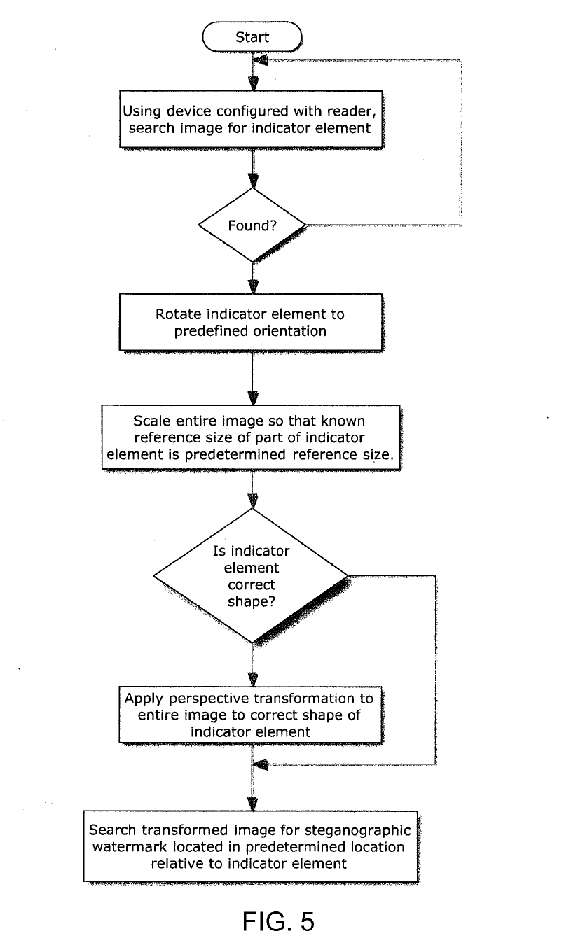

Following is a description of an embodiment of the invention that uses the known parameters of the designator as a reference that allows the app to adjust the code (whether visible or invisible) that it is scanning for distortion. The process steps are illustrated in the flowchart of FIG. 5.

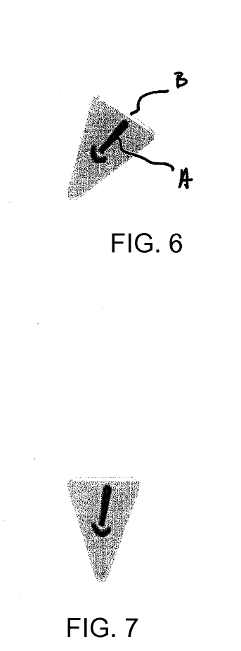

1) Search for the designator, e.g., a predefined logo. This can be done, for example, by searching for pixels of the right color in the image or any known means of image identification. See FIG. 6. In this example the logo is an equilateral triangle, yellow in color, with a red image A resembling an exclamation point in the center, and it has been scanned by the reading device at an angle (side B is considered the top in this example). It is understood that this is used for the purpose of example only and numerous other images can be used as designators and still fall within the scope of this invention.

(2) Once the designator has been located, the entire image is rotated (electronically) so a reference element of the designator is in a certain location/orientation. For example, if the designator looks like the triangle shaped designator shown in FIG. 1, the entire image can be rotated so that the “top” of the triangle (B in FIG. 6) is horizontal as shown in FIG. 7. This can be accomplished, for example by applying a transformation matrix in a known manner. In this example, the designator comprising the logo shown in FIG. 1 has been designed so that the top can be distinguished from the other two sides using the positioning of the interior detail element A.

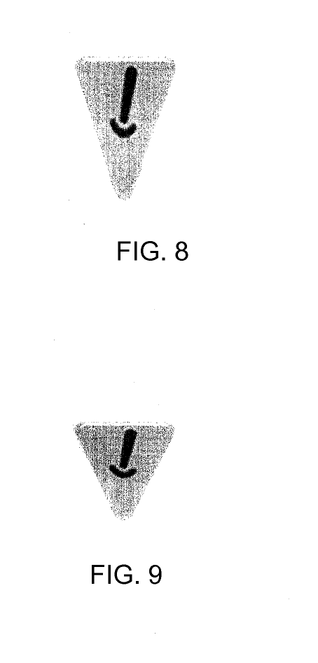

(3) The entire image is then scaled uniformly so that the top of the designator is a known, standard size, and by doing so, the entire width of the image will also be appropriately scaled (See FIG. 8).

(4) A perspective transformation is then applied to the whole image so that the designator is properly shaped and dimensioned (e.g., in the example of FIG. 9), so that the designator is an equilateral triangle as it is in actuality.

(5) Once aligned and adjusted, the entire image is searched for the invisible watermark in a specific location with respect to the visible designator, at a specific scale, with a defined x-to-y size ratio, any distortion in the image having been removed by the transformations.

One potential issue that might be faced is how to choose the parameters of the perspective transformation. For example, it may be difficult to tell the difference between a designator that is small because it is a long way away (and thus there is little perspective distortion) and a designator that is small because it's just small, but close. The present invention solves this potential problem by using the autofocus mechanism of the camera to measure and provide distance information regarding the distance from the camera lens to the image. Once this distance is known the amount of perspective distortion will also be known. One example of how this calculation can be performed on an Android platform can be found at http://developer.android.com/reference/android/hardware/Camera.Parameters.html#getFocusDistances(float[ ]). It is understood that similar calculations can be made using other platforms (e.g., iPhone) and thus such other calculation methods are considered disclosed herein.

In an alternative embodiment, to determine the proper perspective, once the image has been viewed and the designator (and image) have been properly oriented and “returned” to the proper shape, the imaged designator can be overlaid on the “ideal” (i.e., known or predetermined) designator created by the app, and the difference between the locations of the edges of the transformed image and the ideal image can be computed, and then the image adjusted to obtain the proper scale and perspective. For example, one way of automating the adjustment of the camera's view of the target is to modify the transformation matrix experimentally, so that the transformed image of the printed target alignment indicator lies as closely as possible on top of the reference target alignment indicator known to the phone. An algorithm for this is described as follows:

Using an image recognition program, determine whether each pixel in the view of the camera is either inside (1) or outside (0) the outline of the printed target alignment indicator. Initially, compute a value of the transformation matrix that will cause at least one pixel of the transformed camera view of the printed target alignment indicator to lie inside the phone's reference target alignment indicator, and make that the current transformation matrix. Use the current transformation matrix to transform the position of each pixel inside the camera's view of the printed target alignment to an equivalent location on the phone's display of the live view of the camera feed, where the reference target alignment indicator is located. Count how many pixels (a) inside and (b) outside the reference target alignment indicator intersect a pixel from the transformed view of the printed target alignment indicator. Compute a single goodness-of-fit measure c=a−b. Make small changes to the numbers in the transformation matrix and recompute the number c. If c increases, accept the change in the transformation matrix, and make that the current one. If c decreases, undo the change in the transformation matrix. Repeat this process until c reaches a maximum.

It is worth noting that this alignment process does not require the live view of the camera, or the phone's reference target alignment indicator, actually to be displayed to the user. The phone does the alignment automatically as long as the camera can see the watermark.

All of this can be done in hardware, because graphics hardware already exists to provide arbitrary transformations of images. It's used in iPhone to draw animated graphics. It can also be done in software.

The above-described steps can be implemented using standard well-known programming techniques. The novelty of the above-described embodiment lies not in the specific programming techniques but in the use of the steps described to achieve the described results. Software programming code which embodies the present invention is typically stored in permanent storage. In a client/server environment, such software programming code may be stored with storage associated with a server. The software programming code may be embodied on any of a variety of known non-transitory media for use with a data processing system, such as a diskette, or hard drive, or CD ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

It will be understood that each element of the illustrations, and combinations of elements in the illustrations, can be implemented by general and/or special purpose hardware-based systems that perform the specified functions or steps, or by combinations of general and/or special-purpose hardware and computer instructions.

These program instructions may be provided to a processor to produce a machine, such that the instructions that execute on the processor create means for implementing the functions specified in the illustrations. The computer program instructions may be executed by a processor to cause a series of operational steps to be performed by the processor to produce a computer-implemented process such that the instructions that execute on the processor provide steps for implementing the functions specified in the illustrations. Accordingly, a typical computer, smartphone, or other processing device containing at least one processor, memory, input and output capability and display capability, as well as “reading” functionality of some kind (e.g., a camera) provide combinations of means for performing the specified functions, combinations of steps for performing the specified functions, and program instruction means for performing the specified functions.

While there has been described herein the principles of the invention, it is to be understood by those skilled in the art that this description is made only by way of example and not as a limitation to the scope of the invention. Accordingly, it is intended by the appended claims, to cover all modifications of the invention which fall within the true spirit and scope of the invention.

We claim:

1. A method for targeting coded content contained in media content, comprising:
embedding a designator in the media content; and
positioning a reading device to read the coded content by aligning a sensing element of the reading device with the designator.

2. The method of claim 1, further comprising:
activating the reading device to acquire the coded content based on the alignment of the sensing element with the designator.

3. The method of claim 2, wherein the acquiring of the coded content comprises directing a browser on the reading device to a website associated with the coded content.

4. The method of claim 1, wherein the designator has a first predetermined geometry and wherein said reading device perceives the designator, the perceived designator having a second geometry, said method further comprising:
configuring a processor to transform the second geometry to be consistent with the first predetermined geometry, thereby enabling said coded content to be optimized for acquisition by the reading device.

5. A device for acquiring coded content contained in media content, wherein the media content has embedded therein a designator that identifies an approximate location of the coded content, the device comprising:
a sensing element which reads coded content;
alignment means for aligning the sensing element with the designator;
a processor processing the coded content and directing the taking of an action based on the processing of the coded content.

6. The device of claim 5, wherein said sensing element comprises a camera element.

7. The device of claim 6, wherein camera element includes a viewing screen, and wherein said alignment means comprises a replica of the designator located on the viewing screen.

8. The device of claim 5, wherein said device further comprises a smartphone.

9. The device of claim 5, wherein said device further comprises a tablet computing device.

10. A method of transforming a geometry of a perceived image of an actual image perceived by an image-reading device, comprising:
embedding a designator in the actual image;
perceiving the actual image using said image-reading device;
using the perceived image to transform any coded information in the actual image into an improved configuration for detection by an algorithm.

11. A method of optimizing the operation of an algorithm for decoding detected information in an image, using a device's perceived view of the image.
